(19) United States
(12) Patent Application Publication
(10) Pub. No.: US 2010/0103348 A1
(43) Pub. Date: Apr. 29, 2010

(54) DISPLAY

(75) Inventor: Ta-Chang Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/436,118

(22) Filed: May 5, 2009

Related U.S. Application Data
(60) Provisional application No. 61/108,026, filed on Oct. 24, 2008.

(51) Int. Cl. G02F 1/13357

(52) U.S. Cl. 349/64; 349/62

(57) ABSTRACT

A display including a display panel, a transparent rear plate, a backlight module, and a first optical film set is provided. The transparent rear plate has a first surface, a second surface, and an optical decoration. The first surface is facing the display panel, and the second surface is relatively far away from the display panel. The optical decoration is located on at least one of the first and second surfaces. The backlight module is disposed between the display panel and the transparent rear plate. The first optical film set is disposed between the backlight module and the transparent rear plate. Combination of the optical decoration, the backlight module, and the first optical film set forms a plurality of images which can be displayed on the second surface of the transparent rear plate.

### CROSS-REFERENCE TO RELATED APPLICATION

This application claims the priority benefit of U.S.A. provisional application Ser. No. 61108026, filed on Oct. 24, 2008. The entirety of the above-mentioned patent application is hereby incorporated by reference herein and made a part of specification.

### BACKGROUND OF THE INVENTION

1. Field of the Invention

The present invention generally relates to a display, in particular, to a display having a rear plate capable of displaying diversified images.

2. Description of Related Art

With technology development, users raise more and more demands on products. Currently, in addition to more and better functions, product uniqueness and high brand recognition are well considered by the users in purchasing.

Taking a notebook for example, a hollow-out pattern generally serving as a brand logo is formed on a color rear plate of the display. When the notebook is powered on, most of the light provided by a backlight module in the display is irradiated to the display panel, and a small part thereof is emitted to the color rear plate and leaked by the hollow-out pattern, so as to lighten the logo.

### SUMMARY OF THE INVENTION

Accordingly, the present invention is directed to a display having a rear plate capable of displaying diversified images.

A display including a display panel, a transparent rear plate, a backlight module, and a first optical film set is provided. The transparent rear plate has a first surface, a second surface, and at least one optical decoration. The first surface is facing the display panel, and the second surface is relatively far away from the display panel. The optical decoration is located on at least one of the first and second surfaces. The backlight module is disposed between the display panel and the transparent rear plate. The first optical film set is disposed between the backlight module and the transparent rear plate, wherein combination of the optical decoration, the backlight module, and the first optical film set forms a plurality of images which can be displayed on the second surface of the transparent rear plate.

In a display according to an embodiment of the present invention, the display panel is a liquid crystal display (LCD) panel.

In a display according to an embodiment of the present invention, a material of the transparent rear plate is polycarbonate (PC), acrylonitrile-butadiene-styrene (ABS) resin, or a polymer of PC and ABS resin.

In a display according to an embodiment of the present invention, the first optical film set includes first optical films and at least one of the first optical films has a hologram phase deviation microstructure.

In a display according to an embodiment of the present invention, the first optical film set includes diffuser sheets, reflective sheets, brightness enhancement films, or a combination thereof.

In a display according to an embodiment of the present invention, the backlight module includes a light source and a light guide plate. The light guide plate, disposed between the display panel and the first optical film set, has a first light-emitting surface, a second light-emitting surface, and a light incident surface connected between the first light-emitting surface and the second light-emitting surface. The light incident surface is facing the light source, the first light-emitting surface is facing the display panel, and the second light-emitting surface is facing the first optical film set. The light source may be a light-emitting diode (LED) or a cold cathode fluorescent lamp (CCFL).

In a display according to an embodiment of the present invention, the backlight module further includes a second optical film set disposed between the light guide plate and the display panel. The second optical film set includes diffuser sheets, reflective sheets, brightness enhancement films, or a combination thereof.

In a display according to an embodiment of the present invention, the display of the present invention further includes an electromagnetic interference (EMI) protection layer disposed between the transparent rear plate and the first optical film set for protection against interference by electromagnetic waves. The EMI protection layer may be formed by bonding aluminium foil onto the first surface or by sputtering metal onto the first surface.

The display of the present invention achieves effects such as optical interference, refraction, and diffraction by the combination of the optical decoration of the transparent rear plate, the backlight module, and the hologram phase deviation microstructure of the first optical film set so as to further form diversified images on the transparent rear plate and display the images on the second surface of the transparent rear plate.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a display according to a first embodiment of the present invention.

FIG. 2A is a schematic view of a display in an OFF state.

FIG. 2B is a schematic view of the display in FIG. 2A in an ON state.

FIG. 3 is a schematic view of a display according to a second embodiment of the present invention.

FIG. 4 is a schematic view of a display according to a third embodiment of the present invention.

FIG. 5 is a schematic view of a display according to a fourth embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### Embodiment 1

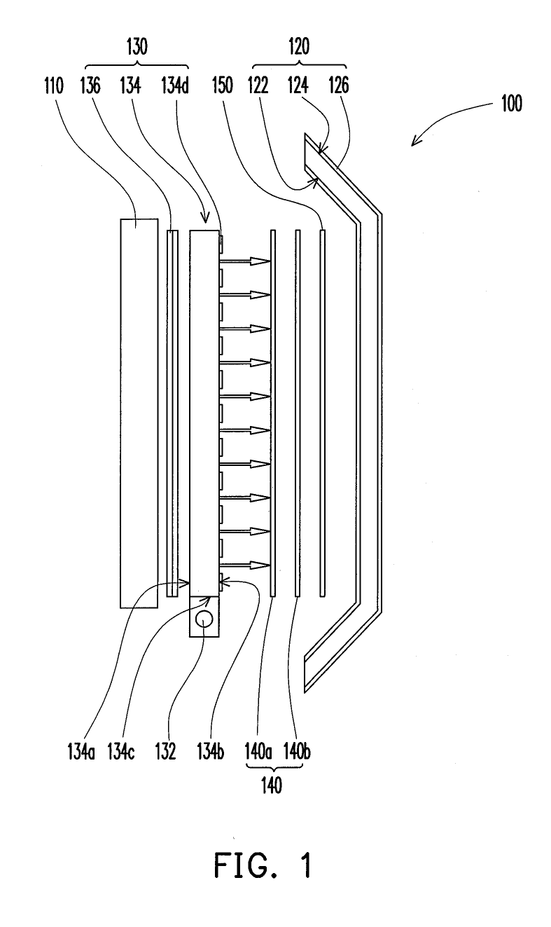

FIG. 1 is a schematic view of a display according to a first embodiment of the present invention. Referring to FIG. 1, the display 100 may be, but not limited to, a display of a desk-top computer, a tablet computer, a notebook, or a handheld electronic device. The display 100 includes a display panel 110, a transparent rear plate 120, a backlight module 130, and a first optical film set 140. The transparent rear plate 120 has a first surface 122, a second surface 124, and at least one optical decoration 126. The first surface 122 is facing the display panel 110, and the second surface 124 is relatively far away from the display panel 110. The optical decoration 126 is located on at least one of the first surface 122 and the second surface 124 (In FIG. 1, the optical decoration 126 is formed on both the first surface 122 and the second surface 124). The backlight module 130 is disposed between the display panel 110 and the transparent rear plate 120. The first optical film set 140 is disposed between the backlight module 130 and the transparent rear plate 120. The combination of the first optical film set 140 and the optical decoration 126 may interfere and refract with the light provided by the backlight module 130, so as to show diversified images on the transparent rear plate 120 and the images are displayed on the second surface 124.

In addition, the optical decoration 126 is formed on the transparent rear plate 120 by in mold rolling (IMR), in mold forming (IMF), two side IMR, vacuum heat transfer (VHT), heat transfer, hot stamping, 3D printing, or 3D painting with laser carving. The display panel 110 may be an LCD panel or other non-self-illuminating display panels. A material of the transparent rear plate 120 may be PC, ABS resin, or a polymer of PC and ABS resin depending on requirements. It should be mentioned that the display panel 110 may also be a self-illuminating display panel and then the backlight module 130 may not need to be disposed in the display 100. Further, the first optical film set 140 may comprise diffuser sheets, reflective sheets, brightness enhancement films, or a combination thereof depending on requirements. The first optical film set 140 of this embodiment is exemplified by a reflective sheet 140a and a brightness enhancement film 140b. A surface of the reflective sheet 140a facing the display panel 110 is a reflective surface. A surface of the brightness enhancement film 140b facing the display panel 110 may be a reflective surface and a surface of the brightness enhancement film 140b facing the transparent rear plate 120 may increase brightness.

The backlight module 130 includes a light source 132 and a light guide plate 134. The light guide plate 134 is disposed between the display panel 110 and the first optical film set 140. The light source 132 is a light-emitting diode (LED) or a cold cathode fluorescent lamp (CCFL). The light guide plate 134 has a first light-emitting surface 134a, a second light-emitting surface 134b, and a light incident surface 134c. The light incident surface 134c is connected between the first light-emitting surface 134a and the second light-emitting surface 134b, and facing the light source 132. Further, the first light-emitting surface 134a is facing the display panel 110, and the second light-emitting surface 134b is facing the first optical film set 140.

The light guide plate 134 further has a light guiding pattern 134d located on the second light-emitting surface 134b upon requirements. The light guiding pattern 134d can increase the light source utilization ratio of the backlight module 130 and improve the display quality of the display 100.

Moreover, the backlight module 130 further includes a second optical film set 136. The second optical film set 136 may comprise a diffuser sheet, a reflective sheet, a brightness enhancement film, or a combination thereof depending on requirements.

In addition, an electromagnetic interference (EMI) protection layer 150 is further disposed between the brightness enhancement film 140b and the transparent rear plate 120. The EMI protection layer 150 may be a coated film layer formed by bonding aluminium foil onto the first surface 122 or by sputtering metal with laser carving on the first surface 122 for preventing electromagnetic waves in the surrounding environment from affecting display quality of the display 100.

Further referring to FIG. 1, when the light source 132 of the backlight module 130 emits light, the light from the light source 132 will be irradiated to the light guide plate 134 through the light incident surface 134c. Next, the light path is guided by the light guide plate 134, such that most of the light is emitted toward the display panel 110, and a part of the light is emitted toward the transparent rear plate 120. Seen from FIG. 1, the light travelling toward the transparent rear plate 120 passes through the reflective sheet 140a, the brightness enhancement film 140b, and the optical decoration 126 of the transparent rear plate 120, such that the images displayed on the transparent rear plate 120 can be viewed by others facing the rear side of the display 100. Particularly, as the reflective sheet 140a and the brightness enhancement film 140b work together with the optical decoration 126, interference as well as refraction of light is generated, and thus different depth-of-field effects, bright and dark contrasts or gradients, and gradient variations of patterns may occur to the images displayed on the transparent rear plate 120, or different patterns may be viewed from different viewing angles. That is, the images showed on the transparent rear plate 120 being viewed from the rear side of the display 100 have diversified variations on brightness, gradient, and depth of field.

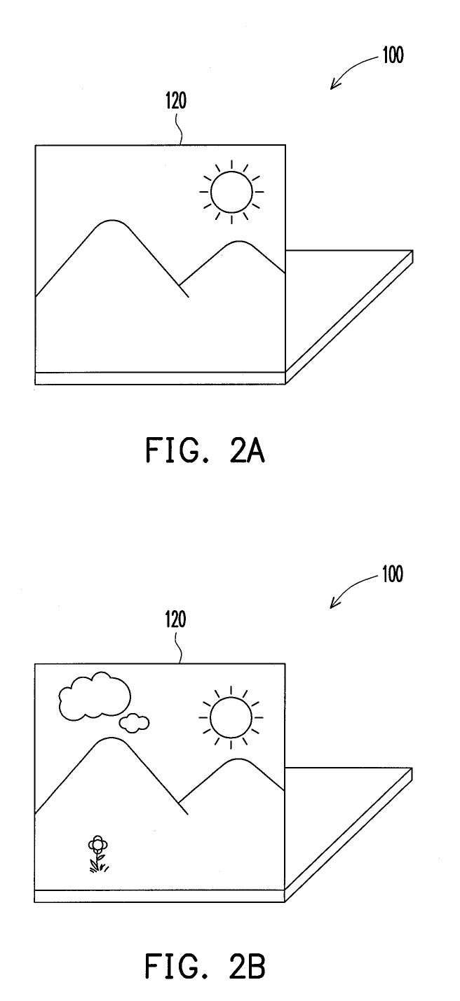

FIG. 2A is a schematic view of a display in an OFF state, and FIG. 2B is a schematic view of the display in FIG. 2A in an ON state. Referring to FIGS. 1, 2A, and 2B together, the display 100 in FIGS. 2A and 2B is a display of a notebook. When the display 100 is in an OFF state, patterns of the optical decoration 126 are showed on the transparent rear plate 120 and viewed from the rear side of the display 100. The patterns, for example, are a sun and mountains. Further, predetermined patterns such as clouds, flowers, and grass, can be formed on the reflective sheet 140a and the brightness enhancement film 140b in advance so when the display 100 is turned on, the light provided by the backlight module 130 enables the patterns of the reflective sheet 140a and the brightness enhancement film 140b to be projected onto the transparent rear plate 120. Thereby, the images showed on the transparent rear plate 120 and viewed from the rear side of the display 100 include the sun, mountains, clouds, flowers, and grass. Definitely, the patterns formed on the optical decoration 126 or the reflective sheet 140a and the brightness enhancement film 140b may also be the brand logos, so as to improve the brand recognition and make good impressions of the brand. According to the above, the patterns displayed by the optical decoration 126 and the patterns of the reflective sheet 140a and the brightness enhancement film 140b are determined upon requirements.

In particular, variations of the images in terms of brightness, gradient, and depth of field viewed from the rear side of the display 100 may be achieved by overlapping the patterns of the reflective sheet 140a, the brightness enhancement film 140b, and the optical decoration 126. For example, when the patterns on the reflective sheet 140a and the brightness enhancement film 140b are hollow-out patterns and are partially overlapped, the image displayed on the transparent rear plate 120 viewed from the rear side of the display 100 is relatively darker at the position corresponding to the overlapped portion of the patterns. If the patterns on the reflective sheet 140a and the brightness enhancement film 140b are light diffusion patterns, the image displayed on the second surface 124 of the transparent rear plate 120 is relatively brighter at the position corresponding to the overlapped portion of the patterns. Moreover, light sources 132 of different colors can be employed to achieve gradient variations in color of the images.

In addition, the display 100 may further include an ambient light sensor (not shown). The ambient light sensor may be disposed at any position of the display 100 capable of receiving external lights for detecting the ambient brightness of the display 100. When the ambient brightness is high, the ambient light sensor is regulated to decrease the brightness of the light source 132, and when the ambient brightness is low, the ambient light sensor is regulated to increase the brightness of the light source 132. Further, although the optical decoration 126 is formed simultaneously on the first surface 122 and the second surface 124 of the transparent rear plate 120 in this embodiment, those of ordinary skill in the art may also form the optical decoration 126 on one of the first surface 122 and the second surface 124 of the transparent rear plate 120. Besides, the images displayed by the transparent rear plate 120 may vary with time or settings of the user through circuit designs.

Seen from the above, compared with the conventional displays, the images displayed by the transparent rear plate 120 of the display 100 of this embodiment are variable and more novel.

### Embodiment 2

This embodiment is substantially the same as the first embodiment. Identical or similar symbols represent the same or similar elements, and the details will not be described herein again.

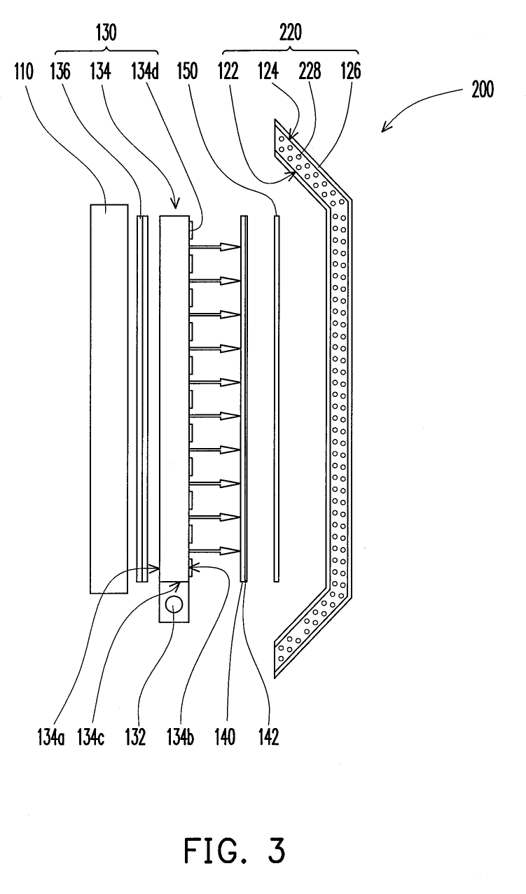

FIG. 3 is a schematic view of a display according to a second embodiment of the present invention. Referring to FIG. 3, the difference between the display 200 of this embodiment and the display 100 of the first embodiment lies in that, the first optical film set 140 in the display 200 of this embodiment is a diffuser sheet with an optical interference pattern 142. Further, the transparent rear plate 120 has a plurality of colored particles 228. That is, when the transparent rear plate 220 is injection-molded, the colored particles 228 are added into the molding compound. The colored particles 228 may also enable the light to be diffused uniformly. Compared with the first embodiment, when the transparent rear plate 220 is molded, the colored particles 228 are uniformly dispersed therein, such that the images displayed by the transparent rear plate 220 may achieve a uniform brightness. While in the first embodiment, the images displayed by the transparent rear plate 120 obtain brightness variations in special areas through the patterns on the reflective sheet 140a and the brightness enhancement film 140b.

### Embodiment 3

This embodiment is substantially the same as the first embodiment. Identical or similar symbols represent the same or similar elements, and the details will not be described herein again.

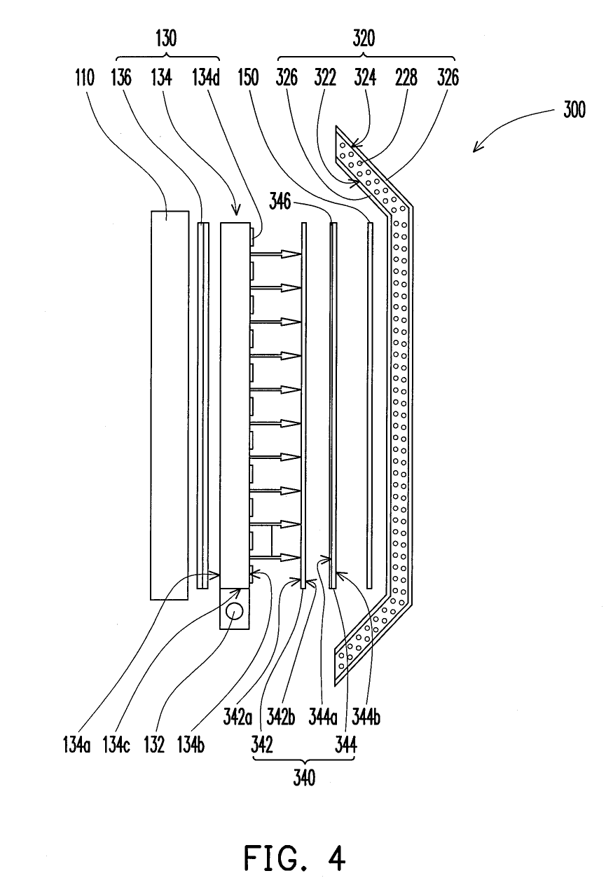

FIG. 4 is a schematic view of a display according to a third embodiment of the present invention. Referring to FIG. 4, the difference between this embodiment and the first embodiment lies in that, a first optical film set 340 of this embodiment includes a reflective sheet 342 and a diffuser sheet 344. A surface 342a of the reflective sheet 342 is a reflective surface and the other surface 342b of the reflective sheet 342 is a brightness enhancement surface. A surface 344a of the diffuser sheet 344 has a hologram phase deviation microstructure 346 and a surface 344b of the diffuser sheet 344 is a diffuser surface. In addition, a first surface 322 and a second surface 324 of a transparent rear plate 320 both have an optical decoration 326 disposed thereon.

When light passes through the hologram phase deviation microstructure 342, an obvious diffraction effect is generated, thus causing interference between the lights. Further, due to the existence of the optical decorations 326, a rainbow pattern or images with 3D visual effects can be displayed on the second surface 324 of the transparent rear plate 320 of the display 300.

### Embodiment 4

This embodiment is substantially the same as the third embodiment. Identical or similar symbols represent the same or similar elements, and the details will not be described herein again.

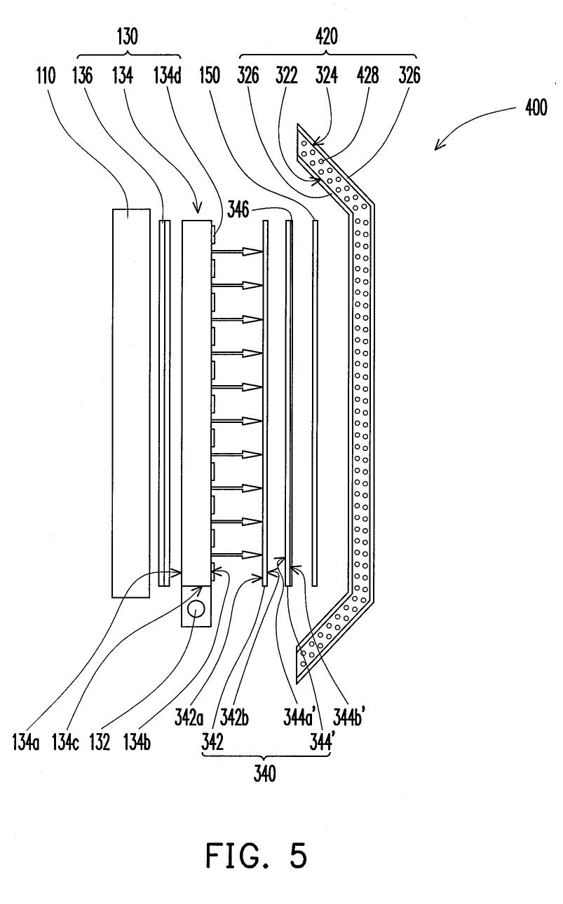

FIG. 5 is a schematic view of a display according to a fourth embodiment of the present invention. Referring to FIG. 5, the difference between this embodiment and the first embodiment lies in that, a first optical film set 340 of this embodiment includes a reflective sheet 342 and a brightness enhancement film 344′. A surface 342a of the reflective sheet 342 is a reflective surface and a surface 342b of the reflective surface 342 is a brightness enhancement surface. A surface 344a′ of the brightness enhancement film 344′ is a brightness enhancement surface and a surface 344b′ of the brightness enhancement film 344′ has a hologram phase deviation microstructure 346. Further, a transparent rear plate 420 has a plurality of colored particles 428, and the colored particles 428 may enable the light to be diffused uniformly.

The reflective sheet 342, the brightness enhancement film 344′, the hologram phase deviation microstructure 346, and the optical decoration 326 may enhance the local brightness of the images displayed on the transparent rear plate 320 of the display 300. Further, the colored particles 428 of the transparent rear plate 420 may bring about more variations in color of the images displayed on the transparent rear plate 320.

Although the first optical film sets in the above four embodiments are merely illustrated by brightness enhancement films, diffuser sheets, reflective sheets, or a combination thereof, those of ordinary skill in the art may also use other optical films upon requirements.

In view of the above, in the display of the present invention, by using various optical films with different properties, the hologram phase deviation microstructure disposed on the optical films, and the transparent rear plate as well as the optical decoration thereof, the images displayed on the transparent rear plate may achieve different depths of field, local brightness variations, gradient performance of color or pattern, rainbow pattern, and 3D visual effects. Further, due to the circuit design and color of the light source, the images displayed by the transparent rear plate of the display may have abundant variations.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display, comprising:
a display panel;
a transparent rear plate, provided with a first surface, a second surface, and at least one optical decoration, wherein the first surface is facing the display panel, the second surface is relatively far away from the display panel, and the optical decoration is located on at least one of the first and second surfaces;
a backlight module, disposed between the display panel and the transparent rear plate; and
a first optical film set, disposed between the backlight module and the transparent rear plate,
wherein combination of the optical decoration, the backlight module, and the first optical film set forms a plurality of images displayed on the second surface of the transparent rear plate.

2. The display according to claim 1, wherein the display panel is a liquid crystal display (LCD) panel.

3. The display according to claim 1, wherein a material of the transparent rear plate is polycarbonate (PC), acrylonitrile-butadiene-styrene (ABS) resin, or a polymer of PC and ABS resin.

4. The display according to claim 1, wherein the first optical film set comprises a plurality of first optical films and at least one of the first optical films has a hologram phase deviation microstructure.

5. The display according to claim 1, wherein the first optical film set comprises diffuser sheets, reflective sheets, brightness enhancement films, or a combination thereof.

6. The display according to claim 1, wherein the backlight module comprises:
a light source; and
a light guide plate, disposed between the display panel and the first optical film set, and provided with a first light-emitting surface, a second light-emitting surface, and a light incident surface connected between the first and the second light-emitting surface, wherein the light incident surface is facing the light source, the first light-emitting surface is facing the display panel, and the second light-emitting surface is facing the first optical film set.

7. The display according to claim 6, wherein the light source is a light-emitting diode (LED) or a cold cathode fluorescent lamp (CCFL).

8. The display according to claim 6, wherein the backlight module further comprises a second optical film set disposed between the light guide plate and the display panel.

9. The display according to claim 8, wherein the second optical film set comprises diffuser sheets, reflective sheets, brightness enhancement films, or a combination thereof.

10. The display according to claim 1, further comprising an electromagnetic interference protection layer disposed on the first surface of the transparent rear plate.
